(19) United States
(12) Patent Application Publication
(10) Pub. No.: US 2026/0230967 A1
(43) Pub. Date: Aug. 6, 2026

(54) NODES AND METHODS PERFORMED BY NODES

(71) Applicant: Samsung Electronics Co., Ltd., Suwon-si, Gyeonggi-do (KR)

(72) Inventors: Weiwei WANG, Beijing (CN); Hong WANG, Beijing (CN); Lixiang XU, Beijing (CN); Yu PAN, Beijing (CN)

(21) Appl. No.: 19/151,512

(22) PCT Filed: Feb. 15, 2024
(86) PCT No.: PCT/KR2024/095170

§ 371 Date: Jul. 28, 2025

(30) Foreign Application Priority Data
Feb. 15, 2023 (CN) 202310180340.6

(51) Int. Cl. H04W 36/04; H04W 36/00

(52) U.S. Cl. CPC H04W 36/04; H04W 36/0033; H04W 36/0079

(57) ABSTRACT

The disclosure relates to a 5G or 6G communication system for supporting a higher data transmission rate. Provided are a node and a method performed by the node. A method performed by a first node in a wireless communication system may include: receiving a first message from a second node, wherein the first message may include information of a cell that the first node attempts to access after a failure occurs; and after the failure occurs, performing, by the first node, an access based on the information.

### TECHNICAL FIELD

The present application relates generally to the field of communication, and more particularly to nodes and methods performed by nodes.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre- 5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

The present disclosure relates to a wireless communication system and, more specifically, the present disclosure relates to handling a failure in a handover process for a terminal in the wireless communication system.

### Solution to Problem

According to one aspect of the present disclosure, a method performed by a first node in a wireless communication system is provided. The method may include receiving a second message from a second node. Wherein the first message may include information of a cell that the first node attempts to access after a failure. And after the failure occurs, the first node performs an access based on the information.

In some implementations, in the method performed by the first node, the first message may include at least one of the following information: information indicating configuration information required for the first node to perform a cell selection; information indicating whether the first node can access a cell using the configuration information obtained in advance; information indicating whether the first node can maintain the configuration information obtained in advance, first access timer information for determining whether a failure occurs, and first recovery timer information of a timer used to recover a connection.

In some implementations, in the method performed by the first node, the information indicating configuration information required for the first node to perform a cell selection may comprise at least one of the following information: information indicating identification information of at least one cell that can be selected by the first node, and information indicating a condition required to be satisfied by a cell that can be selected by the first node.

In some implementations, in the method performed by the first node, the information indicating whether the first node can access a cell using the configuration information obtained in advance may include at least one of the following information: information indicating identification information of at least one cell that the first node can attempt to access, information indicating the number of cells that the first node can attempt to access; and information indicating the number of times that the first node can attempt to perform cell access.

In some implementations, in the method performed by the first node, the information indicating whether the first node can maintain the configuration information obtained in advance may include at least one of the following information: information indicating identification information of one or more cells whose configuration information needs to be maintained by the first node, information indicating a condition satisfied by a cell to which the configuration information needs to be maintained by the first node belongs, information indicating identification information of one or more cells whose configuration information needs to be removed by the first node, and information indicating a condition satisfied by a cell to which the configuration information needs to be removed by the first node belongs.

In some implementations, in the method performed by the first node, the first access timer information may include at least one piece of timer length information, and for each piece of timer length information, the first access timer information may comprise at least one of the following information: first cell identification information indicating an identifier of a cell, first state indication information indicating a state of the first node, and first length information indicating a timer length.

In some implementations, in the method performed by the first node, the first recovery timer information may comprise at least one piece of timer length information, and for each piece of timer length information, the first recovery timer information may comprise at least one of the following information: second cell identification information indicating an identifier of a cell, second state indication information indicating a state of the first node, and second length information indicating a timer length.

In some implementations, in the method performed by the first node, the condition required to be satisfied by a cell can be selected by the first node and/or the condition satisfied by a cell to which the configuration information needs to be maintained by the first node belongs may include at least one of the following: a measurement result is greater than a threshold, downlink synchronization information is acquired, the downlink synchronization information is stored, and uplink synchronization information is acquired.

In some implementations, in the method performed by the first node, the condition satisfied by a cell to which the configuration information needs to be removed by the first node belongs may include at least one of the following: a measurement result is smaller than a threshold, downlink synchronization information is not acquired, the downlink synchronization information is not stored, and uplink synchronization information is not acquired.

In some implementations, in the method performed by the first node, the first state indication information and/or the second state indication information may indicate at least one of the following states: a cell is detected, a cell is not detected, downlink synchronization is acquired or completed, downlink synchronization is not acquired or not completed, downlink synchronization information is stored, downlink synchronization information is not stored, an uplink synchronization signal is transmitted, an uplink synchronization signal is not transmitted, uplink synchronization is acquired, uplink synchronization is not acquired, uplink synchronization and downlink synchronization are acquired.

In some implementations, in the method performed by the first node, the failure is associated with a handover triggered by the second node and/or a third node.

In some embodiments, the method performed by the first node may include: a failure occurs after receiving the first message; and recording and/or transmitting failure-related information.

In some implementations, in the method performed by the first node, the failure-related information may include at least one of the following information: information indicating information of a cell obtained when the failure occurs, information indicating a type of a handover associated with the failure, information indicating an interval time associated with the failure, information indicating whether the first node has configured a Layer 1/Layer 2 triggered mobility LTM handover or received a con-figuration message comprising an LTM candidate cell, information indicating a measurement result, information indicating a time difference between events, and information indicating information when attempting to access a network after the failure occurs.

In some implementations, in the method performed by the first node, the information indicating information of a cell obtained when the failure occurs comprises at least one of the following information: information indicating a configured candidate cell and/or state indication information of the first node at the candidate cell, information indicating identification information of at least one cell configured to the first node for measurement, information indicating identification information of at least one cell configured to the first node for synchronization acquisition, information indicating identification information of a cell whose synchronization information is stored by the first node, information indicating the identification information of at least one cell whose measurement result is reported by the first node, and information indicating a target cell for a handover of the first node.

In some implementations, in the method performed by the first node, the information indicating an interval time associated with the failure may include at least one of the following information: information indicating a time interval between receiving a handover command or performing a handover and the failure, and information indicating a time interval between receiving the handover command and receiving the first message.

In some implementations, in the method performed by the first node, the information indicating a time difference between events may include at least one of the following: a time difference between transmitting a Layer 3 measurement result and transmitting a Layer 1 measurement result, a time difference between transmitting the Layer 3 measurement result and receiving an LTM handover command, and a time difference between transmitting the Layer 1 measurement result and receiving an RRC-based handover command.

In some implementations, in the method performed by the first node, the information indicating information when attempting to access a network after the failure occurs may include at least one of the following information: information indicating identification information of at least one cell that the first node attempts to access, and information indicating the number of times that the first node attempts to access the network.

In some implementations, the method performed by the first node may further include: performing a cell selection after the failure occurs; accessing the selected cell; and transmitting a fifth message to a node of the accessed cell and/or the second node and/or a third node and/or other nodes, the fifth message comprising the failure-related information.

In some implementations, in the method performed by the first node, the fifth message may include at least one of LTM failure-related information, and information for indicating a cell selected after the failure occurs.

According to another aspect of the present disclosure, a method performed by a second node in a wireless communication system is further provided. The method may include: transmitting a first message to a first node, wherein the first message comprises information of a cell that the first node attempts to access after a failure occurs; and receiving a fifth message after a failure of the first node occurs, wherein the fifth message comprises failure-related information.

In some implementations, the method performed by a second node may further include: transmitting a second message to a third node, wherein the second message includes information related to a handover of the first node.

In some implementations, in the method performed by the second node, the second message may include at least one of the following information: a radio resource control RRC-based handover command comprising configuration information used by the first node to hand over to a target cell, information for indicating identification information of a target cell selected by the second node, and information for indicating whether the configuration information in the RRC-based handover command is consistent with configuration information stored in the first node.

In some implementations, in the method performed by the second node, the RRC-based handover command is encapsulated into a packet including a sequence number (SN) of a packet data convergence protocol (PDCP).

In some implementations, the method performed by the second node may further include: receiving a third message from the third node, wherein the third message is used for informing a behavior of the third node when instructing the first node to perform a handover.

In some implementations, in the method performed by the second node, the behavior may include at least one of the following: transmitting the RRC-based handover command; transmitting a handover command through a lower layer command; instructing the first node to hand over to a target cell configured by the RRC-based handover command through a lower layer command; and not transmitting the RRC-based handover command.

According to another aspect of the present disclosure, a method performed by a third node in a wireless communication system is further provided. The method may include: transmitting a fourth message including information of a cell that a first node attempts to access after a failure occurs to the first node; and receiving a fifth message after a failure of the first node occurs, wherein the fifth message includes failure-related information.

In some implementations, the method performed by the third node may further include: receiving a second message from a second node; and transmitting a third message to the second node. The second message may include information related to a handover of the first node, and wherein the third message may be used for informing a behavior of the third node when instructing the first node to perform the handover.

According to still another aspect of the present disclosure, a first node is also provided. The first node may include: a transceiver, configured to transmit and receive a signal; and a controller, coupled to the transceiver and configured to perform the method performed by the first node as described above.

According to still another aspect of the present disclosure, a second node is also provided. The second node may include: a transceiver, configured to transmit and receive a signal; and a controller, coupled to the transceiver and configured to perform the method performed by the second node as described above.

According to still another aspect of the present disclosure, a third node is also provided. The third node may include: a transceiver, configured to transmit and receive a signal; and a controller, coupled to the transceiver and configured to perform the method performed by the third node as described above.

According to still another aspect of the present disclosure, a non-transitory computer-readable medium having instructions stored thereon is provided. The instructions, when executed by one or more controllers, enable one or more controllers to perform the methods performed by the first node and/or the second node and/or the third node as described above.

### Advantageous Effects of Invention

According to an embodiment of present disclosure, a terminal can efficiently perform a communication.

### BRIEF DESCRIPTION OF DRAWINGS

FIG. 1 illustrates an exemplary system architecture of a system architecture evolution (SAE).

FIG. 2 illustrates an exemplary system architecture according to various embodiments of the present disclosure.

FIG. 3 illustrates an exemplary flow related to failure handling according to various embodiments of the present disclosure.

FIG. 4 illustrates a block diagram of a node according to an example embodiment of the present disclosure.

FIG. 5 illustrates a block diagram of user equipment according to an example embodiment of the present disclosure.

### MODE FOR THE INVENTION

The following description with reference to the accompanying drawings is provided to assist in a comprehensive understanding of various embodiments of the present disclosure as defined by the claims and their equivalents. This description includes various specific details to facilitate understanding, but should merely be considered exemplary. Accordingly, those of ordinary skill in the art will recognize that various changes and modifications of the various embodiments described herein can be made without departing from the scope and spirit of the present disclosure. In addition, for the sake of clarity and conciseness, the description of well-known functions and structures can be omitted.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It should be understood that the singular forms of “a”, “an” and “the” include plural references unless the context clearly indicates otherwise. Thus, for example, the reference to a “component surface” includes a reference to one or more such surfaces.

The terms “include”, or “may include” refer to the existence of a corresponding function, operation, or component used in various embodiments of the present disclosure, and does not exclude the existence of one or more additional functions, operations or features. Further, the terms “including” or “having” may be construed to denote certain characteristics, numbers, steps, operations, constituent elements, components, or combinations thereof, but should not be construed to exclude the pos-sibility of the existence of one or more other characteristics, numbers, steps, operations, constituent elements, components, or combinations thereof.

The term “or” used in various embodiments of the present disclosure includes any of the listed terms and all combinations thereof. For example, “A or B” may include A, may include B, or may include both A and B.

Unless defined otherwise, all terms (including technical and scientific terms) used in the present disclosure have the same meaning as commonly understood by those of ordinary skill in the art. Common terms, as defined in a dictionary, are construed to have a meaning consistent with the context in the related art and should not be interpreted ideally or overly formally unless expressly so defined in the present disclosure.

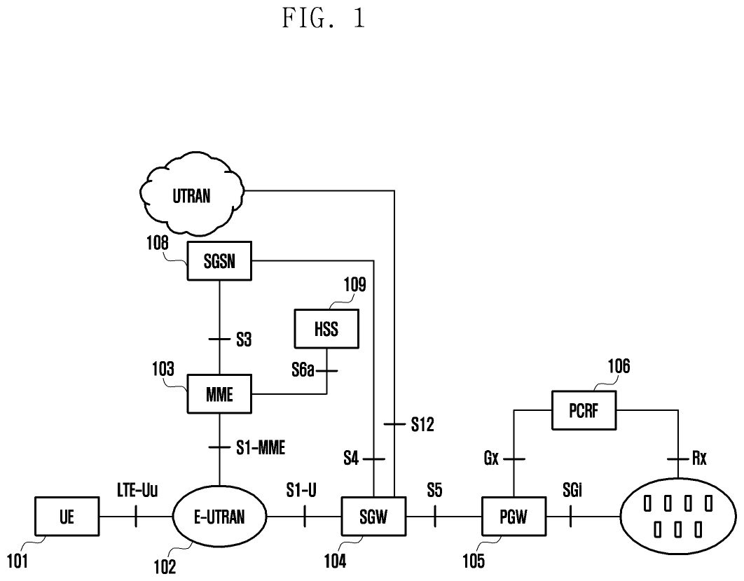

FIGS. 1 to 5 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 illustrates an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful in-terception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

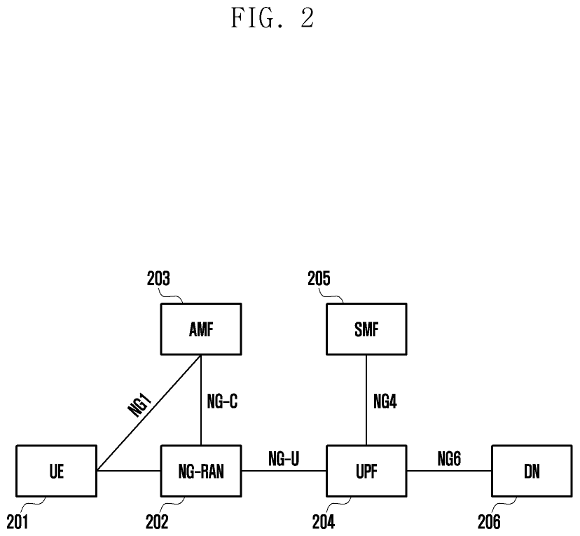

FIG. 2 illustrates an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (e.g., a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

In the mobile network, the user equipment may perform a handover between different cells. The main problem caused by handover is that a user may have a communication interruption in this process. The main causes for the interruption are that the user needs to measure for a long time; before the handover, a network side needs to perform signaling interaction between different nodes to determine a target cell and its configuration, and then transmits a handover command to the user; and hereafter, the user also needs to perform uplink and downlink synchronization with the network. In this process, the user needs a long time to switch the cell, which affects the performance of the user in the mobility procedure.

Before introducing the specific content, some assumptions and some definitions of the present disclosure are given below.
Message names in the present disclosure are just examples, and other message names may be used.
The “first” and “second” etc., included in the message name of the present disclosure are only used to distinguish one message from another, and do not represent the execution order.
Detailed description of steps unrelated to the present disclosure is omitted herein.
In the present disclosure, steps in each flow may be executed in combination with each other or independently. The execution steps of each flow are only examples, and other possible execution steps and/or order are not excluded.
In the present disclosure, a base station may be a 6G base station, a 5G base station (e.g., a gNB, a ng-eNB), a 4G base station (e.g., an eNB), and may also be other types of access nodes.
In the present disclosure, when a cell accessed by the user equipment changes from one cell to another, the behavior may be called a handover or a cell switch. In the following description, handover and cell switch have the same meaning.
In the present disclosure, synchronization information may include at least one of the following information:
   Downlink synchronization information
   Uplink synchronization information, such as timing advance information

The nodes involved in the present disclosure include:
First node: user terminal equipment, which may be a mobile phone, or a relay node
Second node: a central unit of a base station, or a control plane portion of the central unit of the base station, or a base station
Third node: a distributed unit of a base station

The base station involved in the above second/third node may be one of the following types (and other types that may be used for a user terminal to access are not excluded):
Long Term evolution (LTE) base station
5G base station
6G base station
Non-Terrestrial Network (NTN) base station
High Altitude Platform Station (HAPS)
Drone base station
WIFI access point

In the mobility procedure, a user equipment may start a handover (cell switch) according to a signaling of a network side. In order to speed up the user equipment handover flow, the signaling of the network side may be a signaling from a lower layer (a Layer 1 signaling, e.g., a physical layer signaling, downlink control information (DCI)), a Layer 2 signaling, e.g., a medium access control (MAC) layer signaling, a MAC control element (MAC-CE)). The user equipment may access a target cell after receiving the signaling. However, the user equipment may encounter a failure in the access process. This failure may be related to a lower layer signaling triggered handover. The lower layer signaling triggered handover is different from a con-ventional radio resource control (RRC)-based signaling triggered handover. Therefore, how to assist the user equipment in handling the failure in the process of handover (e.g., but not limited to, the lower layer signaling triggered handover) is an urgent problem to be solved.

After encountering the failure in the process of performing the lower layer signaling triggered handover, the user equipment may perform a rapid failure recovery based on information obtained in the handover process (e.g., synchronization information, information of candidate cells, etc.), and may record some failure-related information, so as to provide the failure-related information to a network after re-accessing the network to help the network side acquire the cause of the failure and solve the failure.

Steps involved in the message appearing in the above process are given below. The numbers of the following steps do not represent the execution order of the steps. The following steps can be executed separately or in combination with each other.

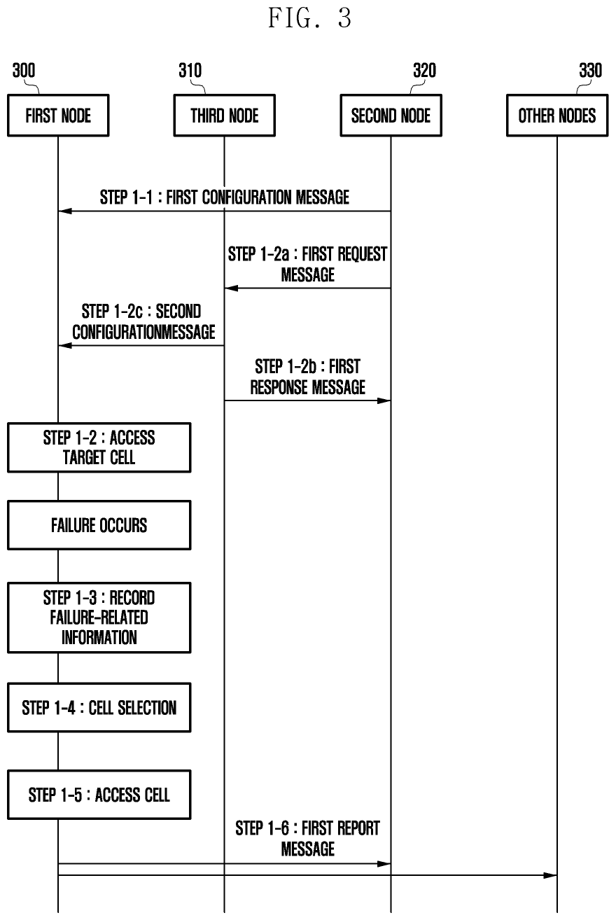

In order to help the user equipment to handle the failure in the handover process, the network side needs to perform a configuration process related to the failure handling for the user equipment. The configuration process may include the following steps, as shown in FIG. 3.

Step 1-1. Transmitting a first message by a second node (320) to a first node (300). In some implementations, the first message may comprise a first configuration message. The following is illustrated by taking the first configuration message as an example of the first message. The function of the message is to configure the user equipment to handle the failure. In one embodiment, the message may include information of a cell that the first node attempts to access after a failure occurs. In one embodiment, the message may include information related with at least one access that the first node (300) attempts to perform after the failure occurs. In one embodiment, the failure occurs in the process of the handover, such as a RRC signaling triggered handover, a lower layer signaling triggered handover (e.g., L1/L2 triggered mobility (LTM)). In another embodiment, the failure occurs prior to the handover (e.g., prior to receiving a signaling for triggering the handover, in one example, the signaling is an RRC signaling, in another example, the signaling is a lower layer signaling, e.g., a MAC layer signaling, an L1 layer signaling, etc.). In another embodiment, the failure occurs after the handover is completed (e.g., after the first node (300) accesses a target cell, after the first node (300) completes uplink and/or downlink synchronization with the target cell). Possible examples of the above “failure” are at least one of the following: a radio link failure, a handover failure, and an LTM failure. In addition, the first configuration message may also be used to configure candidate cells of the first node (300) (e.g., candidate cells for a conditional handover, candidate cells for an LTM handover) and configurations required for accessing the candidate cells. The first configuration message has the beneficial effect that when encountering a failure, the first node (300) can rapidly access a new cell, thus reducing interruption caused by the failure. The first configuration message may include at least one of the following information:
1) First cell selection indication information, which indicates configuration information required by the first node for cell selection after the failure occurs. After the failure occurs, the first node needs to select an appropriate cell to recover the communication with the network. The indication information has the beneficial effects of helping the first node to rapidly select an appropriate cell for access and thus reducing the communication interruption caused by the failure. The information may include at least one of the following information:
1) First cell list information, which indicates identification information of at least one cell that can be selected by the first node (300), i.e., “first cell identification information”. Furthermore, the order of the each cell identified by the identification information in the list may also be used to represent a priority for selecting the cell, for example, a cell at a first entry in the list have the highest priority, a cell at a second entry in the list has the second priority, and so on. Alternatively, for example, a cell at the last entry in the list has the highest priority, a cell at the second-last entry in the list has the second priority, and so on. In another example, in order to represent the priority of each cell in the list, the information may also explicitly indicate the priority of each cell
1) First cell selection condition information, which indicates a condition required to be satisfied by a cell that can be selected by the first node (300). The condition indicated by the information may be at least one of the following conditions:
2) Measurement result is greater than a threshold. In one example, the measurement result may be a Layer 1 measurement result, e.g., Layer 1 reference signal received power (RSRP), reference signal received quality (RSRQ), or received signal strength indicator (RSSI) etc., Further, the “first cell selection condition information” may also include respective threshold information corresponding to the respective measurement result
2) Downlink synchronization information is acquired, i.e., the first node (300) may select a cell with which downlink synchronization is acquired or completed to access
2) Downlink synchronization information is stored, i.e., the first node (300) may select a cell whose downlink synchronization information is stored to access
2) Uplink synchronization information is acquired (or timing advance information is acquired), i.e., the first node (300) may select a cell whose uplink synchronization information (such as timing advance information) is acquired to access

After the failure occurs, the first node (300) may select a cell according to the above “first cell list information”. In one example, the first node (300) may select one of the cells indicated by the above “first cell identification information” (e.g., select a cell with the best signal strength, or select a cell with a signal strength exceeding a certain threshold, or select a cell with a signal strength exceeding a certain threshold and with the best signal strength) to access. In another example, the first node (300) may select a cell with the highest priority to access according to the above “first cell list information”, and further, the cell is a cell with the highest priority among the cells with the signal strength exceeding a certain threshold. In another example, the first node (300) may select a cell that satisfies at least one of the conditions indicated by the “first cell selection condition information” to access. In another example, the first node (300) may select a cell that satisfies at least one of the conditions indicated by the above “first cell selection condition information” among the cells that satisfy the signal strength requirements to access.
1) First configuration attempt indication information, which indicates whether the first node (300) can access a cell using configuration information obtained in advance after failure. The information may be named as an indication of attempting conditional (re)configuration (attemptCondReconfig), an indication of attempting LTM (re)configuration (attemptLTMReconfig), and an indication of attempting LTM/conditional (re)configuration (attemptLTMCondReconfig). In one example, the con-figuration information obtained in advance may be configuration information of at least one LTM candidate cell obtained by the first node (300). In another example, the configuration information obtained in advance may be configuration information of at least one conditional handover candidate cell obtained by the first node (300). In another example, the configuration information obtained in advance may be con-figuration information of at least one conditional handover candidate cell and/or LTM candidate cell obtained by the first node (300). In addition, the configuration information obtained in advance may be transmitted to the first node through the above “first configuration message”. The information has the beneficial effects of helping the first node (300) to determine the configuration information used when accessing a cell, and speeding up the access of the first node (300) to the cell. The information may be explicit indication information, or implicit indication information. When the information is an implicit indication information, an example behavior of the first node (300) is: if the first node (300) obtains configuration information of at least one LTM candidate cell in advance, then the first node may access an LTM candidate cell using the configuration information (e.g., after the handover fails, the first node (300) can perform a cell access according to the configuration information). Further, the information may include one of the following information:
1) First configuration attempt cell list information, which indicates identification information of at least one cell (e.g., a candidate cell for an LTM handover, a candidate cell for a conditional handover) that the first node (300) can attempt to access, wherein the configuration information used for the attempted access is preconfigured to the first node (300). If the cell selected by the first node (300) is a cell in the list, the first node (300) may access the cell using the preconfigured configuration information. In addition, when the first node makes multiple attempts, the information may also be used to indicate cells that the first node (300) can attempt to access when attempting to perform multiple cell accesses. In one example, if the first node (300) fails after attempting to access all cells in the list, then the first node (300) stops attempt, or enter an idle state
1) First configuration attempt cell number information, which indicates the number of cells that the first node (300) can attempt to access. In one example, configuration information of a cell that the first node (300) attempts to access is preconfigured to the first node (300). If the number indicated by the information is two, the first node (300) may select at most two different cells to access. That is, when failed to access the first selected cell, the first node (300) may further select the second cell to access. In one example, when the number of the cells that the first node (300) attempts to access is the number indicated by the information, and no access is successful, the first node stops attempt, or enters an idle state
1) First configuration attempt number information, which indicates the number of times that the first node (300) can attempt cell access. If the number of times is set to be two, when failing to access a selected cell, the first node (300) may further attempt to access a cell for the second time. In these two attempts, the cells selected by the first node (300) may be the same, or different. In one example, if both two access attempts fail, then the first node stops attempt, or enters an idle state

After receiving the information, if failure occurs, the first node (300) may select a cell from the “first configuration attempt cell list information” and access the cell according to configuration information related to the cell obtained in advance. Or the first node (300) firstly selects a cell (e.g., selects a cell according to signal strength, or selects a cell according to configuration of the “first cell selection indication information”), and if the selected cell is in the “first configuration attempt cell list information”, then the first node (300) may access the cell according to the configuration information obtained in advance. In one example, the first node (300) stops attempt or enters an idle state if failing to access the selected cell. In another example, when the first node can attempt to access a cell multiple times, it may attempt multiple times according to the “first configuration attempt cell list information” and/or “first con-figuration attempt cell number information” and/or “first configuration attempt number information”, and stop attempt or enter an idle state after certain condition is satisfied (e.g., access to all cells in the “first configuration attempt cell list information” fails, and/or the number of attempted cells reaches the number indicated by the “first con-figuration attempt cell number information”, and/or the number of attempts reaches the number indicated by the “first configuration attempt number information”).
1) First configuration maintenance indication information, which indicates whether the first node (300) can continue to maintain the configuration information obtained in advance. Specifically, the configuration information obtained in advance is con-figuration information of at least one cell. Further, the at least one cell is a candidate cell for the LTM handover or a candidate cell for the conditional handover. In addition, the information may also indicate whether the first node (300) can continue to maintain obtained synchronization information of at least one cell (e.g., downlink synchronization information, uplink synchronization information, timing advance information). The information has the beneficial effect that the first node (300) can continue to maintain configuration information of some candidate cells, thus reducing communication interruption when the first node (300) subsequently accesses, or hands over to, the cell. Further, the information may further include one of the following information:
1) First configuration maintenance cell list information, which includes identification information of at least one cell, and indicates that the first node (300) needs to maintain configuration information of one or more cells in the cell list information
1) First configuration maintenance condition information, which indicates a condition that should be satisfied by a cell to which configuration information required to be maintained by the first node (300) belongs. The condition indicated by the information may be at least one of the following conditions:
2) Measurement result is greater than a threshold. In one example, the measurement result may be a Layer 1 measurement result, e.g., RSRP or RSRQ or RSSI of Layer 1, etc. Further, the “first configuration maintenance condition information” may also include respective threshold information corresponding to the respective measurement result
2) Downlink synchronization information is acquired, i.e., the first node (300) may select a cell with which downlink synchronization is acquired or completed to access
2) Downlink synchronization information is stored, i.e., the first node (300) may select a cell whose downlink synchronization information is stored to access
2) Uplink synchronization information is acquired (or timing advance information has been acquired), i.e., the first node (300) may select a cell whose uplink synchronization information (e.g., timing advance information) is acquired to access
1) First configuration removal cell list information, which includes identification information of at least one cell, and indicates that the first node (300) needs to remove configuration information of one or more cells in the cell list information
1) First configuration removal condition information, which indicates a condition that should be satisfied by a cell to which configuration information needs to be removed by the first node (300) belongs. The condition indicated by the information may be at least one of the following conditions:
2) Measurement result is smaller than a threshold. In one example, the measurement result may be a Layer 1 measurement result, such as RSRP or RSRQ or RSSI of Layer 1, etc. Further, the “first configuration removal condition information” may further include respective threshold information corresponding to the respective measurement result
2) Downlink synchronization information is not acquired, i.e., the first node (300) may select a cell with which downlink synchronization is completed to access, and/or the first node (300) may select a cell whose downlink synchronization information is not acquired to remove
2) Downlink synchronization information is not stored, i.e., the first node (300) may select a cell whose downlink synchronization information is stored to access, and/or the first node (300) may select a cell whose downlink synchronization information is not stored to remove
2) Uplink synchronization information is not acquired (or timing advance information is not acquired), i.e., the first node (300) may select a cell whose uplink synchronization information (such as timing advance information) is acquired to access, and/or the first node (300) may select a cell whose uplink synchronization information is not acquired to remove

After a failure occurs and selecting a cell (or accesses a cell), the first node (300) may determine whether it is necessary to remove or retain configuration information (and/or synchronization information) of at least one cell (which may or may not include the cell selected by the first node) obtained in advance according to the indication information.
1) First access timer information, which is used for the first node (300) to determine whether a failure occurs, and indicates a length of the timer. In one example, after the timer is started, if the first node (300) has not accessed a cell prior to the expiry of the timer, it is considered that the first node (300) fails to access the cell. The length indicated by the information may vary according to a state of the first node. The information has beneficial effects that the first node (300) may select an appropriate timer length according to the state thereof, preventing the first node (300) from waiting for a long time before determining a failure, speeding up access of a new cell by the first node (300) after the failure occurs, and reducing interruption caused by the failure. The information may include multiple pieces of timer length information. For one piece of timer length information, the information may include at least one of the following information:
1) First cell identification information, which indicates an identifier of a cell to which the “first access timer information” is directed. In one example, the cell is a candidate cell, such as a candidate cell for a conditional handover, or a candidate cell for an LTM handover
1) First state indication information, which indicates a state of the first node. Further, the state indicated by the information is a state of the first node for a cell identified by the “first cell identification information”. The state indicated by the information may include at least one of the following states:
2) Cell is detected (not detected)
2) Downlink synchronization is acquired (or not acquired), or downlink synchronization is completed (or not completed)
2) Downlink synchronization information is stored (not stored)
2) Uplink synchronization signal (e.g., random access preamble information) is transmitted (not transmitted)
2) Uplink synchronization is acquired (or not acquired), e.g., timing advance information is acquired (or not acquired)
2) Uplink synchronization and downlink synchronization are acquired (or not acquired)
1) First length information, which indicates a length of the timer. In one example, the information may be specific time length information (duration, e.g., in seconds, milliseconds, frames, subframes, slots, orthogonal frequency division multiplexing (OFDM) symbols, etc.). In another example, the information may be percentage information or fraction information. The first node (300) may calculate the length of the timer based on the information and reference length information

The above information indicates that the length of the timer may be different due to different cells, may be different due to different states of the first node, or may be different due to different states of the first node in different cells. After receiving the information, the first node can start the timer when a certain condition is satisfied. One example of the condition is that the first node (300) receives a handover command message (e.g., an RRC-based handover command, a lower layer handover command, e.g., a handover command from a physical layer, and a handover command from a MAC layer, e.g., an LTM command). Another example is that the first node (300) receives a handover command but does not obtain synchronization information (e.g., uplink synchronization information, e.g., timing advance information) of a cell (such as a candidate cell). When starting the timer, the first node (300) may determine the length of the timer according to the “first access timer information”. For example, when accessing a cell indicated by the “first cell identification information”, a length indicated by the “first length information” is adopted. Alternatively, when accessing a cell indicated by the “first cell identification information”, the state of the first node is a state indicated by the “first state indication information”, then a length indicated by the “first length information” is adopted. After the timer is started, the first node (300) may stop the timer after accessing a cell. If the first node (300) has not accessed a cell after the expiry of the timer, then the first node (300) can determine a failure for accessing the cell. In addition, the first node (300) may not start the timer, if the first node (300) has obtained uplink resources of a cell before accessing the cell (e.g., before or when receiving the handover command), then the first node (300) does not start the timer.
1) First recovery timer information, where a timer for which the timer information is directed may be a connection recovery timer, i.e., a timer used for the first node (300) to recover a connection with the network after failure, and the information indicates a length of the timer. In one example, after the timer is started, if the first node (300) has not recovered connection with network prior to expiry of the timer, it is considered that the first node fails to recover the connection. The length indicated by the information may be different due to the different states of the first node (300). The information has the beneficial effects that: the first node (300) may select an appropriate timer length for recovering network connection according to state of the first node; preventing the first node (300) from spending a long time for connection recovery in one cell; accelerating the access of the first node (300) to a new cell after the failure; and reducing interruption caused by the failure. The information may include multiple pieces of timer length information. For one piece of timer length information, the information includes at least one of the following information:
1) Second cell identification information, which indicates an identifier of a cell to which the “first recovery timer information” is directed. In one example, the cell is a candidate cell, such as a candidate cell for a conditional handover, or a candidate cell for an LTM handover
1) Second state indication information, which indicates a state of the first node (300). Further, the state indicated by the information is a state of the first node (300) for a cell indicated by the “second cell identification information”. The state indicated by the information may include at least one of the following states:
2) Cell is detected (not detected)
2) Downlink synchronization is acquired (or not acquired), or downlink synchronization is completed (or not completed)
2) Downlink synchronization information is stored (not stored)
2) Uplink synchronization signal (e.g., random access preamble information) is transmitted (not transmitted)
2) Uplink synchronization is acquired (or not acquired), e.g., timing advance information is acquired (or not acquired)
2) Uplink synchronization and downlink synchronization are acquired (or not acquired)
1) Second length information, which indicates a length of the timer. In one example, the information may be specific time length information (a duration, e.g., in seconds, milliseconds, frames, subframes, time slots, orthogonal frequency division multiplexing (OFDM) symbols, etc.). In another example, the information may be percentage information or fraction information, the first node may calculate the length of the timer based on the information and reference length information

The above information indicates that the length of the timer may be different due to different cells, may be different due to different states of the first node, or may be different due to different states of the first node in different cells. After receiving the information, the first node can start the timer when a certain condition is satisfied. One example of the condition is that the first node fails or starts a cell selection, and the other example is that the first node selects an appropriate cell after the failure occurs.

In one example, the first message may be an RRC message, e.g., an RRC Reconfiguration message, a new RRC message, or other types of messages.

In some implementations, the second node may also transmit the first message to a third node. In this case, the third node may receive and retain the first message. In some implementations, the third node may also transmit the first message to the first node. In this case, after receiving the first message from the third node, the first node may attempt to access a cell based on the first message, and access the cell.

Step 1-2. The first node (300) accesses a target cell that is one of at least one candidate cell configured for the first node (300). The candidate cell may be a candidate cell for a conditional handover, or a candidate cell for an LTM handover. In one example, the first node (300) performs a cell access based on a command transmitted by the second node (320) (e.g., an RRC Reconfiguration message). In another example, the first node (300) performs the cell access based on a command transmitted by the third node (310) (e.g., an LTM handover command). In another example, the first node (300) performs the cell access based on configuration information (e.g., configuration information for the conditional handover) in the first configuration message. In the process for accessing the cell, the first node (300) may determine a length of the started timer according to the configuration in the “first access timer information” in Step 1-1, which helps the first node (300) determine whether the access to the cell fails.

Prior to Step 1-2, a signaling triggering the first node (300) to access the target cell may be transmitted by the second node (320), or by the third node (310). Since both the second node (320) and the third node (310) independently determine the transmission of the handover command, the two nodes may transmit handover commands to the first node (300) at the same time or at similar time, resulting in the conflict of the handover commands. To resolve this conflict, the process may also include:

Step 1-2a: transmitting a second message by the second node (320) to the third node (310). In some implementations, the second message may be a first request message, which has the function of transmitting information related to the handover of the first node (300) to the third node (310). The message may include at least one of the following information:
1) An RRC-based handover command, which indicates configuration information used by the first node (300) to hand over to the target cell. In some implementations, the command may be encapsulated into a PDCP packet including a serial number SN of a packet data convergence protocol (PDCP), and then the PDCP packet is placed in a container
1) Target cell identification information, which indicates a target cell selected by the second node (320). The information has the beneficial effects that the third node (310) can know the target cell selected by the second node (320), or determine a target cell indicated by the “RRC-based handover command”, thus helping the third node (310) determine whether to transmit a handover command to the first node (300), such as whether to transmit an LTM command
1) First configuration change indication information, which is used for indicating whether the configuration information included in the “RRC-based handover command” is consistent with the configuration information stored at the first node (300). In one example, it is unnecessary to transmit the “RRC-based handover command” if the configuration information included in the RRC-based handover command is consistent with the configuration information stored at the first node (300). In another example, the “RRC-based handover command” needs to be transmitted if the configuration information included in the RRC-based handover command is inconsistent with the configuration information stored at the first node (300). The information has the beneficial effect of helping the third node (310) determine whether it is necessary to transmit the “RRC-based handover command” to the first node (300)

Step 1-2b. Transmitting a third message by the third node (310) to the second node (320). In some implementations, the third message may be a first response message, which has the function of informing a behavior of the third node (310) when indicating the first node (300) to handover. The message may indicate at least one of the following behaviors:
1) Behavior 1: Transmitting the “RRC-based handover command” in the first request message
1) Behavior 2: Transmitted a handover command to the first node (300) through a lower layer command (an LTM command). Further, the first response message also includes the identification information of a target cell indicated by the handover command
1) Behavior 3: Indicating the first node (300) to hand over to a target cell configured by the “RRC-based handover command” through a lower layer command (an LTM command)
1) Behavior 4: Rejecting the request message transmitted by the second node (320) in Step 1-2a, which indicates that the third node (310) does not transmit the “RRC-based handover command” to the first node (300)

If the behavior indicated by the first response message indicates that the third node (310) does not transmit the “RRC-based handover command” to the first node (300), the second node (320) may reuse the sequence number of the PDCP included in the “RRC-based handover command”. In another example, the third node (310) may inform the second node (320) through the first response message to reuse the sequence number of the PDCP included in the “RRC-based handover command” (e.g., the first response message includes indication information for reusing the sequence number of the PDCP). The beneficial effects for doing this are helping the first node (300) receive continuous PDCP sequence numbers and avoiding delay of the first node (300) when handling data packets.

In one example, the second message may be a UE context modification request message of an F1 interface, other messages of the F1 interface, or a newly defined message. The second message may be a UE context modification response/ failure/reject message of the F1 interface, other messages of the F1 interface, or a newly defined message.

The above process may also include Step 1-2 c (either before or after Step 1-2b), that is, transmitting a fourth message by a third node (310) to the first node (300). In some implementations, the fourth message may be a second configuration message. The following is illustrated by taking the second configuration message as an example of the fourth message. The message has the function of indicating a target cell for the first node (300) to handover. In one example, the second configuration message is the “RRC-based handover command” included in the “first request message”. In another example, the second configuration message is a lower layer handover command (e.g., an LTM command), and the target cell included in the command may be the target cell indicated in Step 1-2a, or a target cell determined by the third node (310).

In some implementations, the third node (310) may also include information included in the first message received from the first node (300) in the fourth message. In this case, the fourth message may further include information of a cell to which the first node (300) attempts to access after the failure occurs.

After the first node (300) receives the first configuration message and/or the second configuration message, the failure may occur at the first node (300) in the process that the first node (300) accesses the target cell, or before the first node accesses the target cell, or after the first node (300) accesses the target cell. When the failure occurs, the process may also include the following steps:

Step 1-3. The first node (300) records failure-related information, which can help network side determine the cause of the failure, and then correct the configuration of the network to reduce the occurrence of failure. The “failure-related information” has the beneficial effects of helping the network side correct the problem causing the failure of the user equipment, avoiding occurrence of failure and reducing interruption of communication between the user equipment and the network. The “failure-related information” may be information related to a failure of an LTM handover, or information related to a failure of a Layer 3 handover. The information may include at least one of the following information:
1) Failure-related cell indication information, which indicates information of the cell obtained by the first node (300) when the failure occurs, which may include at least one of the following information:
1) First candidate cell list information, which indicates candidate cells configured for the first node (300). In one example, the candidate cells may be candidate cells for a conditional handover. In another example, the candidate cells may be candidate cells for an LTM handover. The information includes identification information of at least one cell. Further, for a candidate cell, the information may also include state indication information of the first node (300) at the candidate cell, and a state indicated by the information may be at least one of the following states:
2) Cell is detected (not detected)
2) Downlink synchronization is acquired (or not acquired), or downlink synchronization is completed (or not completed)
2) Downlink synchronization information is stored (not stored)
2) Uplink synchronization signal (e.g., random access preamble information) is transmitted (not transmitted)
2) Uplink synchronization is acquired (or not acquired), e.g., timing advance information is acquired (or not acquired)
2) Uplink synchronization and downlink synchronization are acquired (or not acquired)

The information has the beneficial effects of acquiring (state) information of candidate cells when the failure occurs, and determining whether the failure is caused by an inappropriate target cell selection.
1) First measured cell indication information, which indicates identification information of at least one cell configured to the first node (300) for measurement. In one example, the measurement is a Layer 1 measurement. In another example, the measurement is a Layer 3 measurement. The information has the beneficial effects of determining a set of cells configured to the first node (300) for measurement when the failure occurs, and determining whether the failure is caused by inappropriate configured measurement cells
1) First synchronization acquisition cell indication information, which indicates identification information of at least one cell configured to the first node (300) for synchronization acquisition. One example of the synchronization acquisition is a downlink synchronization acquisition and another example of the synchronization acquisition is an uplink synchronization (e.g., timing advance information) acquisition. The information has the beneficial effect of determining a synchronization state of respective cell when the failure occurs, and determining whether the failure is caused by an inappropriate target cell
1) First synchronization storing cell indication information, which indicates identification information of a cell whose synchronization information is stored by the first node (300). The stored synchronization information may be downlink synchronization information, and/or uplink synchronization information (e.g., timing advance information). The information has the beneficial effect of determining synchronization state of respective cell when the failure occurs, and determining whether the failure is caused by an inappropriate target cell
1) First measurement report cell indication information, which indicates identification information of at least one cell whose measurement result is reported by the first node (300). In one embodiment, the report of the measurement result occurs before configuring an LTM candidate cell to the first node (300). Further, the measurement result may be a Layer 3 measurement result. The information has the beneficial effects of helping the network side obtain the measurement information based on which the LTM candidate cell is configured, and determining whether the failure is caused by unreasonable configuration of the candidate cell
1) First target cell indication information, which indicates a target cell for the first node (300) to hand over. The indication information of the target cell is transmitted to the first node (300) by the handover command, e.g., by an LTM command. Further, the information may further include configuration information used for handing over to the target cell, e.g., TCI (transmission configuration indication) state indication information, and beam indication information. The information has the beneficial effects of determining a configuration used by the first node (300) when the handover is triggered, and determining whether the failure is caused by an inappropriate target cell or an inappropriate used configuration
1) First handover type indication information, which indicates a type of a handover performed before the failure occurs, and/or a type of a handover associated with the failure. The handover type indicated by the information is a handover based on a lower layer signaling (e.g., an LTM triggered handover), a handover based on an RRC signaling, or a non-LTM handover. Further, the information may also be used to indicate a type of the signaling used to trigger the handover of the first node (300), e.g., an RRC signaling, a Layer 1 signaling, a Layer 2 signaling, an LTM signaling, etc. The information has the beneficial effects of determining the type of handover performed by the first node (300) when the failure occurs, and helping the network side correct an inappropriate configuration of the corresponding type of handover
1) First failure-related interval time indication information, which indicates an interval time calculated when the failure occurs. In one embodiment, the indication information indicates an interval time associated with the failure. The information has the beneficial effect of helping the network side acquire the interval time between two events when the failure occurs, so as to determine the cause of the failure according to a length of the interval time (e.g., the handover is too early, the handover is too late, the first node handed over to a wrong cell. The handover may be an RRC-based handover, a conditional handover, or an LTM-based handover). The information may include at least one of the following information:
1) First handover execution interval time, which indicates a length of a time interval between receiving a handover command (e.g., receiving an LTM handover command) or executing a handover based on a lower layer command (e.g., an LTM command) by the first node (300) and the occurrence of failure
1) First configuration occurrence-related interval time, which indicates a length of the time interval between receiving the handover command (e.g., receiving an LTM handover command) and receiving the “first configuration message” for configuring the candidate cell by the first node (300). Further, the length of the time interval refers to a length obtained after the handover failure occurs. In another example, the information indicates a length of the time interval between failure of the first node (300) and reception of the “first configuration message” for configuring the candidate cell.
Further, the length of the time interval refers to a length obtained after a link failure occurs
1) First LTM handover configuration indication information, which indicates whether the first node (300) has configured an LTM handover, or received a con-figuration message including an LTM candidate cell. The information has the beneficial effect of helping the network side determine whether the failure is caused by an inappropriate LTM handover configuration
1) First measurement result indication information, wherein the measurement result is a measurement result obtained by the first node (300). In one example, the measurement result is a measurement result when the failure occurs. In another example, the measurement result is a measurement result obtained by the first node (300) before configuring the candidate cell for a handover (e.g., a conditional handover or an LTM handover) for the first node (300). In another example, the measurement result is a measurement result when the first node transmits a Layer 1 measurement result. In another example, the measurement result is a measurement result collected by the first node (300) before receiving an LTM handover command or an RRC handover command. In another example, the measurement result is a measurement result collected by the first node (300) before receiving a signaling for triggering the first node (300) to transmit an uplink synchronization signal (e.g., permeable) to the candidate cell. The measurement result may be a Layer 1 measurement result, such as L1-RSRP (or L1-RSRQ, L1-RSSI), or a Layer 3 measurement result, such as RSRP (or RSRQ, RSSI). Further, for each measurement result, the information may also include identification information of a corresponding cell. The information has the beneficial effect of helping the network side determine a measurement result when or before the failure occurs, thus determining whether the failure is caused by an inappropriate cell selection
1) First time difference indication information, which indicates a time difference between two events. The information may indicate at least one of the following time differences:
1) Time difference between transmitting a Layer 3 measurement result and transmitting a Layer 1 measurement result by the first node (300). In one example, the time difference is an amount of time advance that the first node transmits the Layer 3 measurement result than transmits the Layer 1 measurement result. In another example, the time difference is an amount of time advance that the first node (300) transmits the Layer 1 measurement result than transmits the Layer 3 measurement result
1) Time difference between transmitting a Layer 3 measurement result and receiving a (LTM) handover command by the first node (300). In one example, the time difference is an amount of time advance that the first node (300) transmits the Layer 3 measurement result than receives the (LTM) handover command. In another example, the time difference is an amount of time advance that the first node (300) receives the (LTM) handover command than transmits the Layer 3 measurement result
1) Time difference between transmitting a Layer 1 measurement result and receiving a (RRC)-based handover command by the first node (300). In one example, the time difference is an amount of time advance that the first node (300) transmits the Layer 1 measurement result than receives the (RRC)-based handover command. In another example, the time difference is an amount of time advance that the first node receives the (RRC)-based handover command than transmits the Layer 1 measurement result

The information has the beneficial effect of helping the network side determine whether a trigger time for the Layer 3 handover (e.g., an RRC signaling-based handover, or a conditional handover) and that for the Layer 1 handover (such as a LTM handover) is inappropriate, thereby correcting trigger conditions of the Layer 1 and Layer 3 handovers.
1) First cell access attempt indication information, which indicates information of the first node (300) when attempting to access the network after the failure occurs. The information may include at least one of the following information:
1) First attempted cell list information, which indicates identification information of at least one cell of a network that the first node attempts to access
1) First attempted number information, which indicates the number of times the first node attempts to access the network

The information has the beneficial effects of helping the network side acquire the information of cell accesses attempted by the first node, to determine selection of an appropriate target cell.

In one example, the “failure-related information” may be recorded in a radio link failure report (RLF report) information element (IE), or in other IEs. The recorded information may be used for the first node (300) to subsequently provide the failure-related information to the network side.

All “cell list information” referred to herein denotes information for indicating at least one related cell, the form of which is not limited to a list, and other forms of data may also be used to indicate at least one related cell without departing from the scope of the present disclosure.

When the failure occurs at the first node (300), the first node (300) can start a connection recovery process (e.g., a reestablishment process, and an RRC reestablishment process), which is mainly used for the first node (300) to re-access a cell and recover communication with the network. The process may also include the following steps:

Step 1-4. The first node (300) performs a cell selection. In one example, the first node (300) may select a cell according to signal strength. In another example, the first node (300) may determine a selected cell according to the “first cell selection indication information” in the “first configuration message”. Further, the first node (300) may start a connection recovery timer according to the “first recovery timer information” in the “first configuration message” after selecting a cell, or start the connection recovery timer when the cell selection is stated or the failure occurs, to help the first node (300) determine whether the connection recovery is successful.

Step 1-5. The first node (300) accesses the selected cell. When the cell selected by the first node (300) is a candidate cell which is pre-configured to the first node (300) for handover (e.g., a candidate cell for a conditional handover, or a candidate cell for a LTM handover), in one example, the first node (300) may access the selected cell according to the pre-configuration. In another example, the first node (300) may determine whether to access the cell using configuration information obtained in advance according to the “first configuration attempt indication information” in the “first configuration message”. Further, after the first node (300) selects the cell to access, the first node (300) may also determine whether to continue to maintain the configuration information obtained in advance and/or the obtained synchronization information according to the “first configuration maintenance indication information” in the “first configuration message”. In addition, in the process that the first node (300) accesses the selected cell, the first node (300) can perform different access processes according to the state thereof, for example:
1) The first node (300) does not acquire downlink synchronization, does not complete downlink synchronization, or does not store downlink synchronization information

The first node (300) may perform a downlink synchronization process and an uplink synchronization (such as RACH) process
1) The first node (300) acquires downlink synchronization, completes the downlink synchronization, or stores the downlink synchronization information The first node (300) may perform an uplink synchronization (such as RACH) process
1) The first node (300) transmits an uplink synchronization signal, such as random-access preamble information, but does not acquire timing advance information

The first node (300) continues to wait for the timing advance information transmitted by the network side until a timer expires
1) The first node (300) acquires uplink synchronization, e.g., acquires the timing advance information

The first node (300) transmits an uplink message using an allocated uplink resource (e.g., UL grant)

After the first node (300) accesses the selected cell, the process may further include the following step:

Step 1-6. Transmitting a fifth message by the first node (300) to a network side device. In some implementations, the fifth message may be a first report message, the network side device is a node serving the cell accessed by the first node (300) (e.g., a cell accessed after the failure occurs), which may be the second node (320) (or the third node (310)), or other nodes (330) different from the second node (320) (or the third node (310)). The message has the function of providing the failure-related information to the network side to help the network side determine cause of the failure, and adjusting configuration used for handover of the user equipment to reduce occurrence of failure. The message may include at least one of the following information:
1) LTM failure-related information. Specifically, the LTM failure is a failure occurring after the LTM-based handover is configured for the first node (300), and for information included in such information, please refer to the “failure-related information” in Step 1-3
1) First selected cell information, which indicates a cell selected by the first node (300) after the failure occurs. Further, the selected cell may be a candidate cell of the LTM

Prior to this step, the process may also include Step 1-6a (not shown), in which a sixth message is transmitted by the network side device to the first node (300). In some implementations, the sixth message may be a second request message for requesting the first node (300) to transmit the first report message. Step 1-6 is triggered only after the first node (300) receives the second request message.

In one example, the fifth message may be a UE information response message, other RRC messages, or a newly defined message. The sixth message may be a UE information request message, other RRC messages, or a newly defined message.

In some implementations, the second node (320) and/or the third node (310) may receive a fifth message from the first node (300). This may include a situation that the second node (320) and/or the third node (310) receives the fifth message directly from the first node (300), or a situation that the second node (320) and/or the third node (310) receives the fifth message via a node of a cell that the first node (300) accesses (e.g., a cell accessed after the failure occurs). This is helpful for the network side to determine the cause of failure, and adjust the configuration used for handover of the user equipment, to reduce occurrence of failure.

Steps 1-4 and 1-5 can be regarded as a connection recovery process of the first node (300). If the first node (300) does not successfully access the selected cell in the Step 1-5, the first node (300) may further determine whether to continue performing of the connection recovery process in Steps 1-4 and 1-5 according to the “first configuration attempt indication information” in the first configuration message.

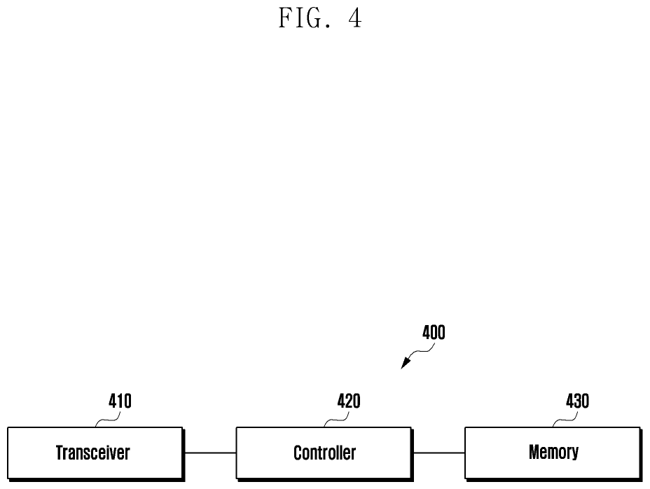

FIG. 4 is a block diagram of a node according to an example embodiment of the present disclosure. The structure and function of a node are described herein as an example, but it should be understood that the structure and function shown can also be applied to a base station (or a central unit of the base station, or a control plane portion of the central unit of the base station, or a user plane portion of the central unit of the base station, or a distributed unit of the base station, etc.).

Referring to FIG. 4, a node 400 includes a transceiver 410, a controller 420, and a memory 430. Under the control of the controller 420 (which may be implemented as one or more processors), the node 400 (including the transceiver 410 and the memory 430) is configured to perform operations of the node described herein. Although the transceiver 410, the controller 420 and the memory 430 are shown as separate entities, they may be implemented as a single entity, such as a single chip. The transceiver 410, the controller 420 and the memory 430 may be electrically connected or coupled to each other. The transceiver 410 may be configured to transmit signals to, and receive signals from, other network entities such as another node and/or a UE etc. In an implementation, the transceiver 410 may be omitted. In this case, the controller 420 may be configured to execute instructions (including computer programs) stored in the memory 430 to control the overall operation of the node 400, thereby implementing operations of the node described herein.

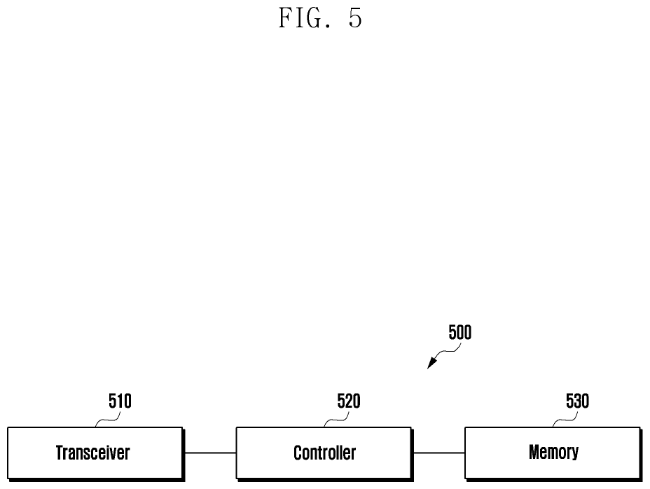

FIG. 5 is a block diagram of a user equipment according to an example embodiment of the present disclosure. In the present disclosure, the terms “user equipment”, “user terminal device”, “user terminal”, “terminal device” may be used interchangeably.

Referring to FIG. 5, the user equipment 500 includes a transceiver 510, a controller 520 and a memory 530. Under the control of the controller 520 (which may be implemented as one or more processors), a user equipment 500 (including the transceiver 510 and the memory 530) is configured to perform the operations of the user equipment described herein. Although the transceiver 510, the controller 520 and the memory 530 are shown as separate entities, they may be implemented as a single entity, such as a single chip. The transceiver 510, the controller 520 and the memory 530 may be electrically connected or coupled to each other. The transceiver 510 may be configured to transmit signals to, and receive signals from, other network entities such as a node or another UE or the like. In an implementation, the transceiver 510 may be omitted. In this case, the controller 520 may be configured to execute instructions (including computer programs) stored in the memory 530 to control the overall operation of the user equipment 500, thereby performing the operations of the user equipment described herein.

Those skilled in the art can recognize that the present disclosure may be implemented in other specific forms without changing the technical idea or essential features of the present disclosure. Therefore, it should be understood that the above embodiments are only examples and are not limitative. The scope of the present disclosure is defined by the appended claims and not limited by the detailed description. Accordingly, it should be understood that all modifications or variations derived from the meaning and scope of the appended claims and their equivalents are within the scope of the present disclosure.

In the above embodiments of the present disclosure, all operations and messages may be selectively performed or may be omitted. Further, the operations in each embodiment do not need to be performed sequentially, and the order of operations may vary. Messages do not need to be sent in order, and the message delivery order may vary. Each operation and each message delivery can be performed independently.

While the present disclosure has been shown and described with reference to various embodiments of the present disclosure, it should be understood by those skilled in the art that various changes may be made in form and details without departing from the spirit and scope of the present disclosure as defined by the appended claims and their equivalents.

1. A method performed by a terminal in a wireless communication system, the method comprising:
receiving, from a base station, a control message including information on a layer 1/layer 2 (L1/L2) triggered mobility (LTM) configuration;
identifying that information associated with an attempt LTM included in the information on the LTM configuration;
identifying a failure is occurred after a LTM is triggered;
selecting a cell based on the failure;
identifying whether the selected cell is included in at least one LTM candidate cell, wherein information on the at least one LTM candidate cell is included in the information on LTM configuration; and
performing a LTM cell switch procedure, in case that the selected cell is included in the at least one LTM candidate cell.

2. The method of claim 1, further comprising:
receiving, from a distributed unit (DU) of the base station, a cell switch command based on a LTM,
wherein a first message to request a mobility for the terminal is delivered from a central unit (CU) of the base station to the DU, and
wherein a second message is delivered from the DU to the CU by indicating an LTM command is triggered to the terminal, as a response to the first message.

3. The method of claim 2,
wherein the request message is an UE context modification request message for mobility, and
wherein the response message is an UE context modification failure message.

4. The method of claim 1, further comprising:
generating failure related information for the LTM; and
transmitting, to the base station, the failure related information for the LTM.

5. A method performed by a base station in a wireless communication system, the method comprising:
generating a control message including information on a layer 1/layer 2 (L1/L2) triggered mobility (LTM) configuration; and
transmitting, to a terminal, the control message including the information on the LTM configuration including information associated with an attempt LTM, the information on the LTM configuration further including information on the at least one LTM candidate cell,
wherein a failure is occurred after a LTM is triggered, by the terminal, a cell is selected based on the failure, in case that the selected cell is included in at least one LTM candidate cell, a LTM cell switch procedure is performed.

6. The method of claim 5, further comprising:
determining, by a central unit (CU) of the base station, to initiate a user equipment (UE) context modification;
delivering, from the CU to a distributed unit (DU) of the base station, a first message to request a mobility for the terminal; and
delivering, from the DU to the CU, a second message by indicating an LTM command is triggered to the terminal, as a response to the first message,
wherein the request message is an UE context modification request message for mobility, and
wherein the response message is an UE context modification failure message.

7. The method of claim 6, further comprising:
transmitting, from the DU to the terminal, a cell switch command based on a LTM before the UE context modification failure message is delivered.

8. A terminal in a wireless communication system, the terminal comprising:
a transceiver; and
at least one processor is configured to:
receive, from a base station via the transceiver, a control message including information on a layer 1/layer 2 (L1/L2) triggered mobility (LTM) configuration,
identify that information associated with an attempt LTM included in the information on the LTM configuration,
identify a failure is occurred after a LTM is triggered, select a cell based on the failure,
identify whether the selected cell is included in at least one LTM candidate cell, wherein information on the at least one LTM candidate cell is included in the information on LTM configuration, and
perform a LTM cell switch procedure, in case that the selected cell is included in the at least one LTM candidate cell.

9. The terminal of claim 8, wherein the at least one processor is further configured to:
receive, from a distributed unit (DU) of the base station, a cell switch command based on a LTM,
wherein a first message to request a mobility for the terminal is delivered from a central unit (CU) of the base station to the DU, and
wherein a second message is delivered from the DU to the CU by indicating an LTM command is triggered to the terminal, as a response to the first message.

10. The terminal of claim 9,
wherein the request message is an UE context modification request message for mobility, and
wherein the response message is an UE context modification failure message.

11. The terminal of claim 8, wherein the at least one processor is further configured to:
generate failure related information for the LTM, and
transmit, to the base station via the transceiver, the failure related information for the LTM.

12. A base station in a wireless communication system, the base station comprising:
a transceiver; and
at least one processor is configured to:
generate a control message including information on a layer 1/layer 2 (L1/L2) triggered mobility (LTM) configuration, and
transmit, to a terminal via the transceiver, the control message including the information on the LTM configuration including information associated with an attempt LTM, the information on the LTM configuration further including information on the at least one LTM candidate cell,
wherein a failure is occurred after a LTM is triggered, by the terminal, a cell is selected based on the failure, in case that the selected cell is included in at least one LTM candidate cell, a LTM cell switch procedure is performed.

13. The base station of claim 12, wherein the at least one processor is further configured to:
determine, by a central unit (CU) of the base station, to initiate a user equipment (UE) context modification,
deliver, from the CU to a distributed unit (DU) of the base station, a first message to request a mobility for the terminal, and
deliver, from the DU to the CU, a second message by indicating an LTM command is triggered to the terminal, as a response to the first message.

14. The base station of claim 13, wherein the request message is an UE context modification request message for mobility, and
wherein the response message is an UE context modification failure message.

15. The base station of claim 12, wherein the at least one processor is further configured to:
transmit, from the DU to the terminal via the transceiver, a cell switch command based on a LTM before the UE context modification failure message is delivered.
